(19) United States
(12) Patent Application Publication
(10) Pub. No.: US 2025/0269771 A1
(43) Pub. Date: Aug. 28, 2025

(54) CHILD SAFETY SEAT

(71) Applicant: Wonderland Switzerland AG, Steinhausen (CH)

(72) Inventor: Yingzhong CHEN, Dongguan,Guangdong (CN)

(73) Assignee: Wonderland Switzerland AG, Steinhausen (CH)

(21) Appl. No.: 18/858,229

(22) PCT Filed: Apr. 21, 2023
(86) PCT No.: PCT/EP2023/060494

§ 371 Date: Oct. 18, 2024

(30) Foreign Application Priority Data
Apr. 21, 2022 (CN) 202210423765.0

(51) Int. Cl. B60N 2/28

(52) U.S. Cl. CPC B60N 2/2806; B60N 2/2821; B60N 2/286; B60N 2/2863

(57) ABSTRACT

The application discloses a child safety seat including a seat body which is engageable to a vehicle seat by a safety belt on the vehicle seat. The child safety seat is mountable to the vehicle seat in a forward position or a rearward position, the child safety seat is provided with a first engagement point and a second engagement point, and in the forward position and the rearward position, the safety belt engages the child safety seat to the vehicle seat through both the first engagement point and the second engagement point along same binding path. The application also discloses a method for engaging the safety belt.

### TECHNICAL FIELD

The application relates to a child safety seat.

### BACKGROUND

A child safety seat is a common device, which can be used by infants of different ages. Child safety seats are designed for children's safety, which can restrain children's dangerous behaviors in a car during driving, and protecting children from injury in the event of accidents such as sudden collisions.

The child safety seat may be mounted to a vehicle seat in a forward position or a rearward position. In the forward position, the child safety seat faces the travel direction of the vehicle, and the backrest portion of the child safety seat abuts against the backrest portion of the vehicle seat. In the rearward position, the child safety seat is facing away from the direction of travel of the vehicle, and the backrest portion of the child safety seat is opposite the backrest portion of the vehicle seat. Generally, the child safety seat is mounted to the vehicle seat by a safety belt of the vehicle (usually a car). Therefore, it is necessary to provide an engagement structure on the child safety seat for engaging the safety belt.

### SUMMARY

A child safety seat according to the application comprises: a seat body, engageable to a vehicle seat by a safety belt on the vehicle seat; characterized in that the child safety seat is mountable to the vehicle seat in a forward position or a rearward position, the child safety seat is provided with a first engagement point and a second engagement point, and in both the forward position and the rearward position, the safety belt engages the child safety seat to the vehicle seat through both the first engagement point and the second engagement point.

In an embodiment, the child safety seat further comprises: a limit member, forming the first engagement point, mounted on a side of an upper part of the seat body, and allowing the safety belt to be passed therein; and a clamp member, forming the second engagement point, mounted at a position on a side of the seat body and below the limit member, and allowing the safety belt to be clamped and passed therein.

In an embodiment, the child safety seat further comprises: a passage, transversely passing through a back of the seat body and located below the clamp member, and the safety belt is able to pass from one side of the child safety seat through the limit member and the clamp member located on that side, as well as the passage, and reach the other side of the child safety seat.

In an embodiment, two limit members are symmetrically arranged on both sides of the seat body and close to a top of the seat body; and there are two clamp members, and two clamp members are symmetrically arranged on both sides of the seat body and located at au upper middle position of the seat body.

In an embodiment, the limit member includes: a limiting piece, extending along a top frame of the seat body, with two ends respectively mounted to a side of the seat body and a part between the two ends separated from a side face of the seat body by a limiting space, the limiting space has a length greater than a width of the safety belt and a thickness greater than a thickness of the safety belt; and a slot, separating the limiting piece into two sections, the slot has a slot width no less than the thickness of the safety belt, to allow the safety belt to enter the limiting space from an outside of the child safety seat through the slot.

In an embodiment, the clamp member includes: a case, embedded in a side face of the seat body; a clamp portion, pivotable about a substantially vertical pivot axis in respect to the case between an open position and a closed position, and when the clamp portion is in the open position, a space is formed between the clamp portion and the case for inserting the safety belt, and when the clamp portion is in the closed position, the clamp portion is able to abut against the case to clamp the safety belt inserted between the clamp portion and the case; and an elastic member, disposed between the case and the clamp portion to bias the clamp portion to the closed position.

In an embodiment, the clamp portion is provided with engaging teeth at an edge abut against the case, and when the clamp portion is in the closed position, the engaging teeth abut against the case to reinforce a clamping of the safety belt; and the clamp portion is provided with an actuating portion at one end of for applying an external force to overcome a biasing of the elastic member, so as to pivot the clamp portion to the open position. In an embodiment, the elastic member is a torsion spring.

In an embodiment, the seat body is provided with protrusions respectively on both sides, and the protrusions are formed in the channel and extend forward from an inner side wall of a back frame of the seat body, so as to limit an upward movement of a portion of the safety belt relative to the seat body.

In an embodiment, the safety belt includes: a shoulder belt, a waist belt, and a fastening member, the shoulder belt and the waist belt respectively extend from upper and lower ends of the vehicle seat and are converged and connected to the fastening member, a length of at least one of the shoulder belt and the waist belt is variable, and the fastening member is connected to a lower end of the vehicle seat through a opposed fastening member on the vehicle seat, such that the safety belt has a triangular configuration.

A safety belt engagement method is provided according to the application for the child safety seat of the application, characterized in that the method comprises: when the child safety seat is mounted to the vehicle seat in the forward position, engaging the safety belt to the first engagement point and the second engagement point on one side of the seat body; and when the child safety seat is mounted to the vehicle seat in the rearward position, engaging the safety belt to the first engagement point and the second engagement point on the other side of the seat body.

### BRIEF DESCRIPTION OF THE DRAWINGS

Embodiments of the application will be described in detail below with reference to the accompanying drawings, in which:

FIG. 1 is a side view of one side of a child safety seat according to the application;

FIG. 2 is an enlarged partial view at the block in FIG. 1;

FIG. 3 is a side view of the other side of the child safety seat;

FIG. 4 is a perspective view of the child safety seat;

FIG. 5 is an enlarged partial view at the block in FIG. 4;

FIGS. 6 and 7 are perspective views of the child safety seat from two different angles;

FIG. 8 is a front view of the child safety seat;

FIG. 9 is a rear view of the child safety seat;

FIG. 10 is a perspective view of the child safety seat in a forward position mounted to a vehicle seat;

FIG. 11 is a side view of the child safety seat in a rearward position mounted to the vehicle seat;

FIGS. 12 and 13 are side and perspective views, respectively, of a clamp member with a clamp portion in an open position;

FIGS. 14 and 15 are side and perspective views, respectively, of the clamp member with the clamp portion in a closed position.

### DETAILED DESCRIPTION

Although the invention is illustrated and described herein with reference to specific embodiments, it should not be limited to the details shown. Specifically, various modifications may be made to these details within the scope of equivalents of claims without departing from the invention.

The directional descriptions such as “front,” “back,” “upper,” and “lower” are referred to herein only for convenience of understanding. The invention is not intended to be limited to the related directions, but can be adjusted according to the actual situation. Although the application is described with reference to typical embodiments, the terminology used is illustrative and exemplary, not restrictive.

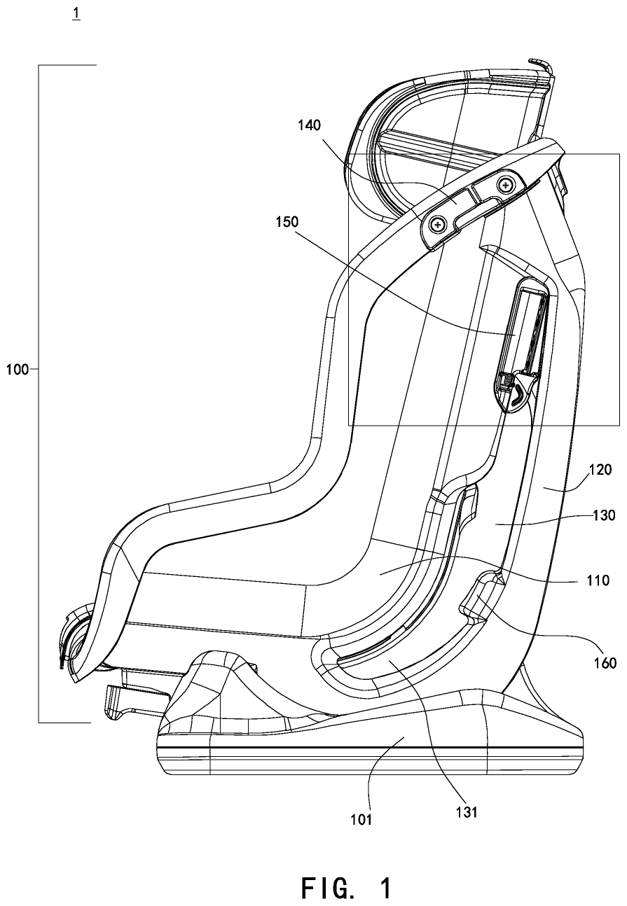

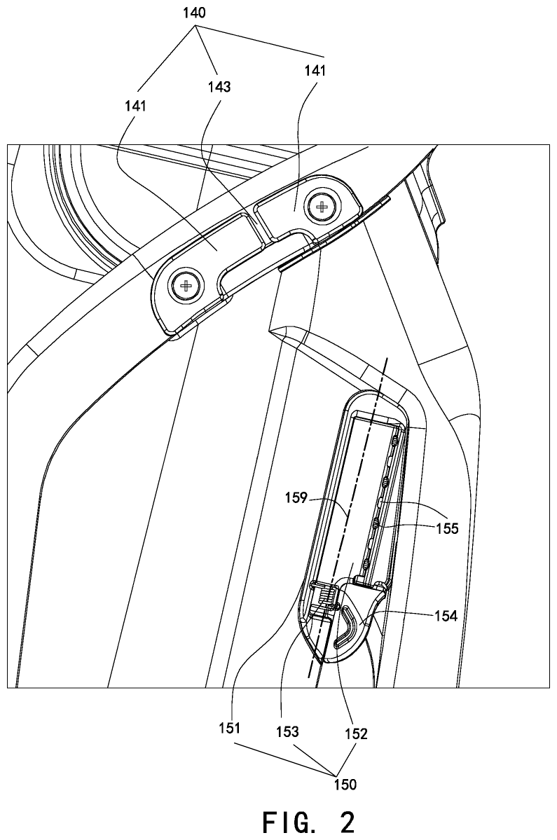

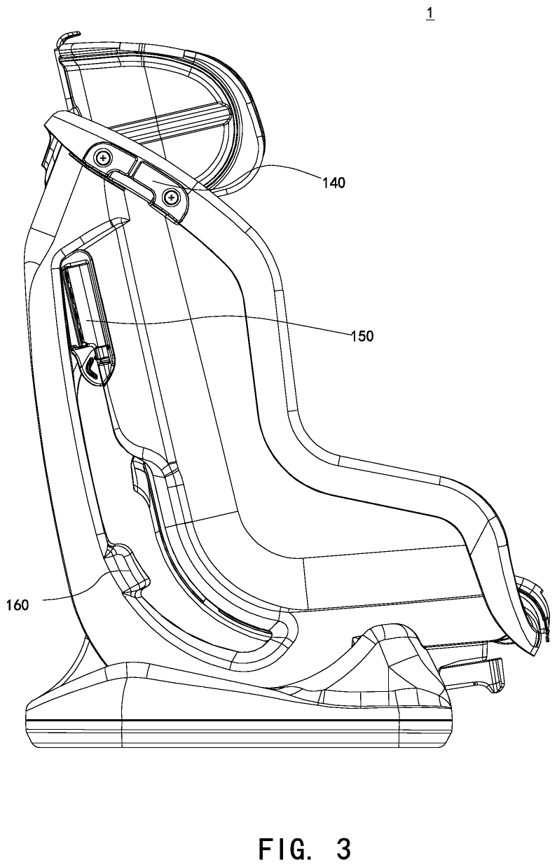

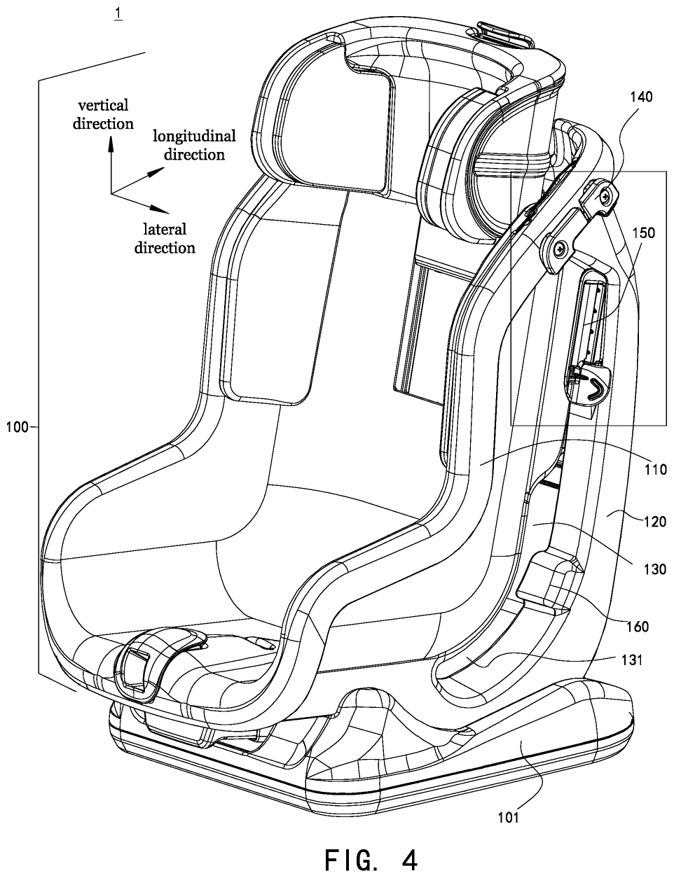

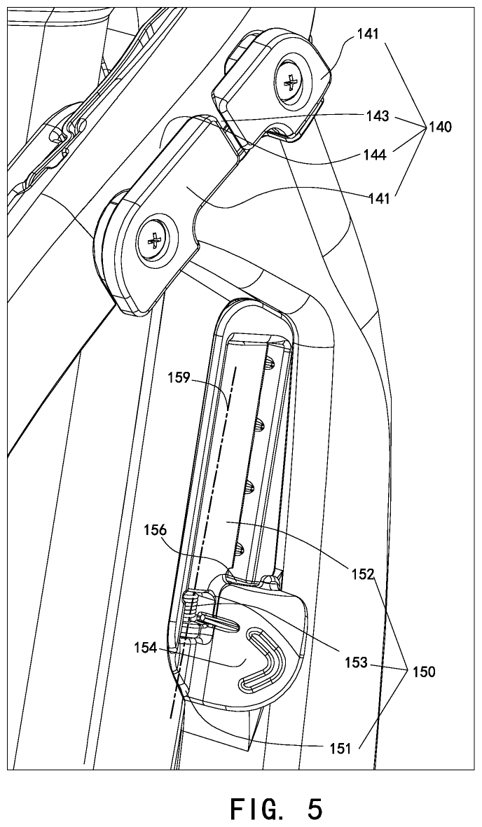

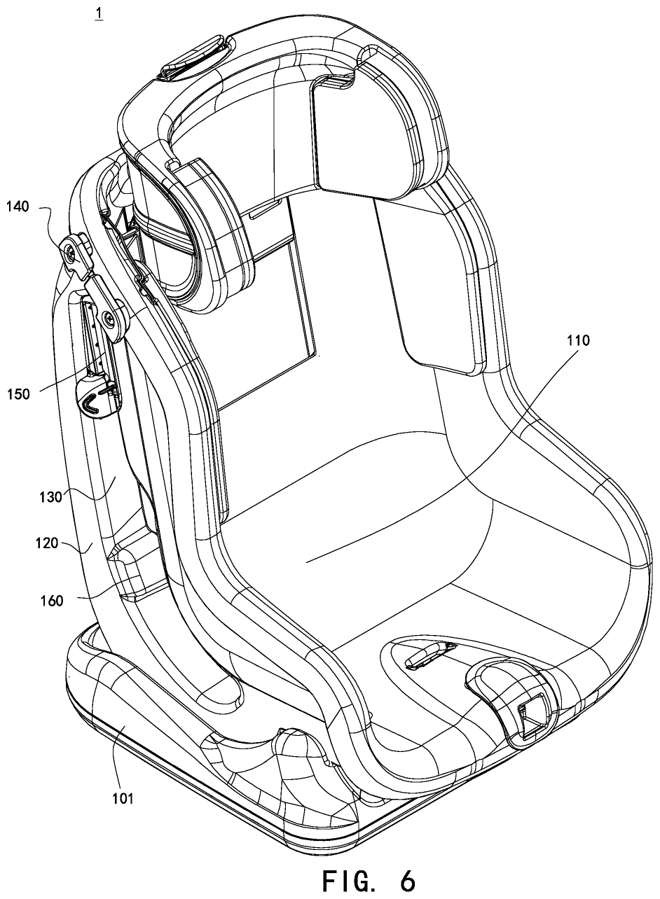

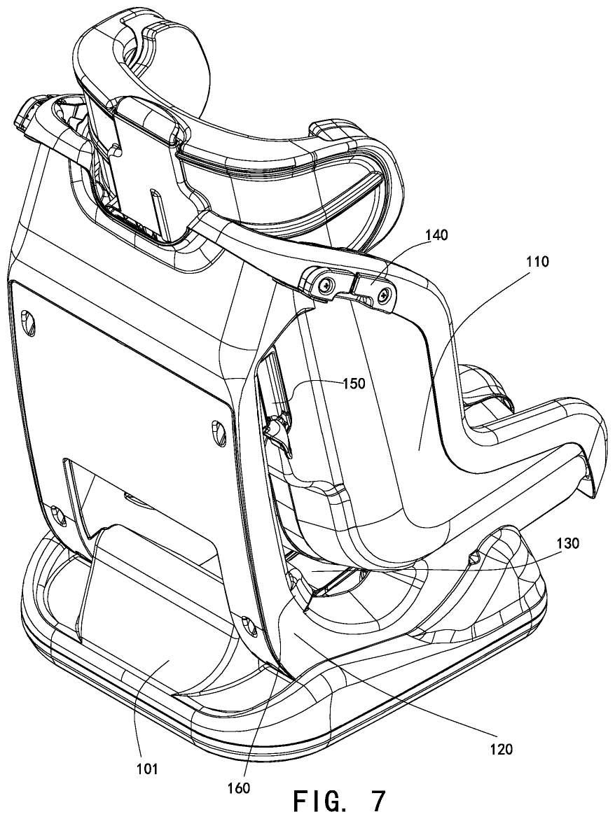

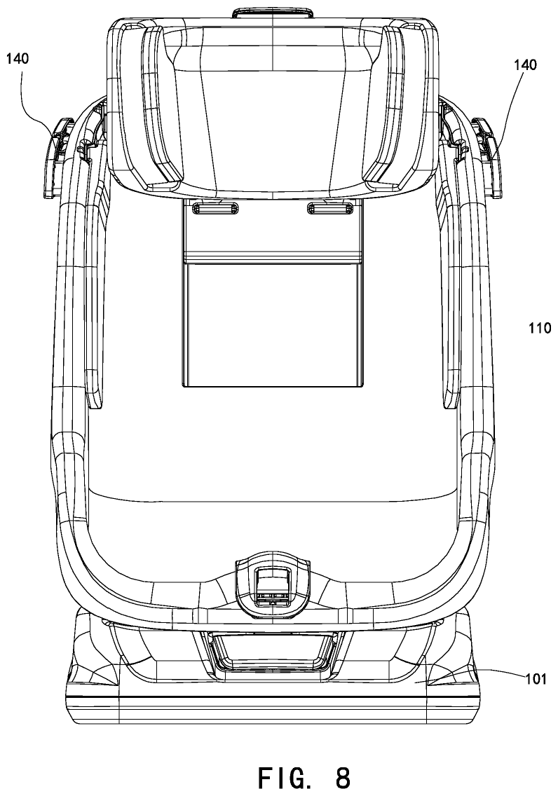

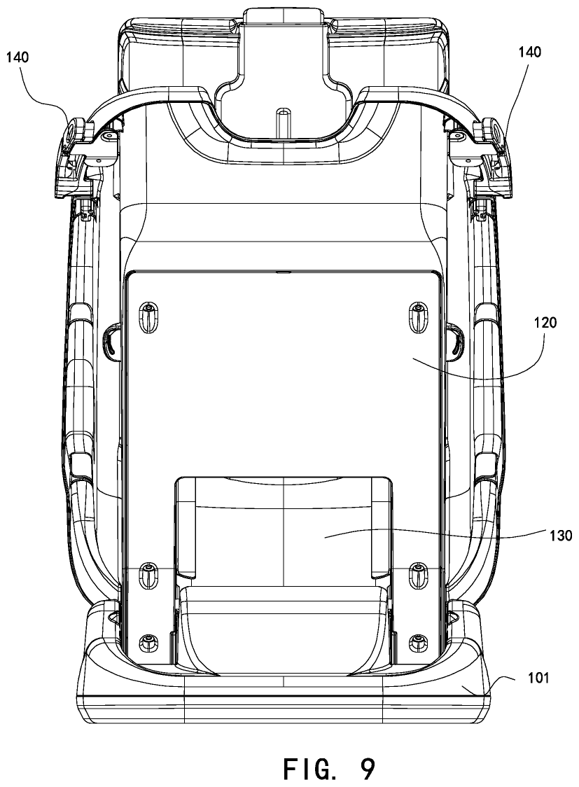

Referring to FIGS. 1 to 10, a child safety seat 1 according to the application will be generally described. The child safety seat 1 comprises a base 101 and a seat body 100. The base 101 is mounted to a vehicle seat 2, and the seat body 100 is disposed above the base 101. In some embodiments, the base 101 may be arranged forward or backward in respect to the vehicle seat 2, such that the seat body 100 is arranged forward or backward accordingly. In other embodiments, an orientation of the base 101 in respect to the vehicle seat 2 is constant, and the seat body 100 can rotate in respect to the base 101, such that the seat body 100 is arranged forward or backward in respect to the vehicle seat 2. The seat body 100 is engaged to the vehicle seat 2 by a safety belt 200 on the vehicle seat 2. In the forward position and the rearward position of the seat body 100, the safety belt 200 engages the child safety seat 1 (especially the seat body 100) to the vehicle seat 2 through same engagement points. The engagement point includes a first engagement point and a second engagement point. More specifically, the first engagement point may be a limit member 140, and the second engagement point may be a clamp member 150.

Regardless of the seat body 100 is used forward or backward, the safety belt 200 is arranged through the same engagement point, so as to ensure that the binding paths of the safety belt 200 for the seat body 100 used forward or backward are the same, thus avoiding misusing of the safety belt 200 and failing to stably engage the child safety seat 1 to the vehicle seat 2. Therefore, safety of the child safety seat 1 in use is greatly improved and effective and reliable protection for children.

The child safety seat 1 includes a limit member 140 and a clamp member 150 for engaging the safety belt 200, and both the limit member 140 and the clamp member 150 are disposed on the seat body 100. The limit member 140 is mounted on a side of an upper part of the seat body 100, and allows the safety belt 200 to be passed therein. The clamp member 150 is mounted at a position on a side of the seat body 100 and below the limit member 140, and allows the safety belt 200 to be clamped and passed therein. More specifically, the limit member 140 may be disposed at a top frame of the seat body 100, and the clamp member 150 is at a distance from the limit member 140 in a vertical direction, for example, about a quarter or a third of the height of the seat body 100. According to actual situation, the vertical distance between the clamp member 150 and the limit member 140 can be larger or smaller, without affecting the technical effect of the application.

To ensure stable installation of the child safety seat 1 to the vehicle seat 2 using a safety belt 200, the height of the limit member 140 is crucial. The limit member 140 bears the acting force and limits the position of the safety belt 140. Increasing the height of the limit member 140 enhances its bearing and limiting effect. However, this also increases the height of the seat body 100. To reduce the height of the seat body 100 while ensuring the seat's bearing, limiting, and tensioning effect on the safety belt 200, the clamp member 150 is positioned below the limit member 140. This helps to maintain the tightness of the safety belt 200 and prevent it from slipping. Apart from providing bearing and limiting effect, the limit member 140 also guides the safety belt 200. This arrangement ensures that the height of the limit member 140 is sufficient, resulting in better bearing and limiting of the safety belt 200. Additionally, the clamp member 150 helps to prevent the safety belt 200 from slipping, maintaining the tightness of the safety belt 200, preventing loosen of the safety belt 200 which will result in improper tightening of the child safety seat 1.

The child safety seat 1 further comprises a passage 130. The passage 130 transversely passes through the back of the seat body 100, and is located below the clamp member 150. In an embodiment, the passage 130 vertically extends from the clamp member 150 to a vicinity of a bottom end of the seat body 100, and continues to bend forward at the vicinity of the bottom end of the seat body 100 to form a longitudinal portion 131. In other words, the seat body 100 includes a seating portion 110 and a back frame 120. The back frame 120 is mounted to top and bottom ends of the seating portion 110, and is spaced apart from the seating portion 110 between the top and bottom ends to form the passage 130.

Passing the safety belt 200 transversely through the passage 130 ensures a more secure attachment of the safety belt 200 to the child safety seat 1. Additionally, the safety belt 200 can be concealed within the passage 130, providing a cleaner appearance for the child safety seat 1.

In this embodiment, the safety belt 200 can reach the other side of the child safety seat 1 from one side the child safety seat 1 through the limit member 140 and/or the clamp member 150 arranged on the one side as well as the passage 130. However, the passage 130 is not necessary. In other embodiments, the back frame 120 may not be provided, thus the passage 130 will not be formed between the seating portion 110 and the back frame 120, that is, the back of the seating portion 110 is completely open. In this way, the safety belt 200 can pass through directly from the back of the seating portion 110 without passing through the passage 130.

In this embodiment, there are two limit members 140, and the two limit members 140 are symmetrically arranged on both sides of the seat body 100 and close to the top of the seat body 100. There are two clamp members 150, and the two clamp members 150 are symmetrically arranged on both sides of the seat body 100 and located at an upper middle position of the seat body 100. In other embodiments, the two the limit members 140 on both sides can be arranged asymmetrically, and the two clamp members 150 can also be arranged asymmetrically.

The symmetric arrangement of limit members 140 and clamp members 150 allows for the safety belt 200 to be attached to either side of the child safety seat 1 using the same engaging manner.

More specifically, each of the limit members 140 includes a limiting piece 141 and a slot 143. The limiting piece 141 extends along the top frame of the seat body 100. Two ends of the limiting piece 141 are respectively mounted to a side of the seat body 100, and the portion between the two ends is separated from a side face of the seat body 100 by a gap. A length of the gap is greater than a width of the safety belt 200, and a thickness of the gap is greater than a thickness of the safety belt 200, thus forming a limiting space 144 for the safety belt 200 with its entire width to pass through with. The slot 143 separates the limiting piece 141 into two sections, and the slot width of the slot 143 is slightly larger than the thickness of the safety belt 200, so as to allow the safety belt 200 to enter the limiting space 144 from the outside of the child safety seat 1 through the slot 143.

The structure of the limit member 140 allows for easy insertion and removal of the safety belt 200, while also ensuring that the safety belt 200 is securely clamped in the limit member 140 during a collision.

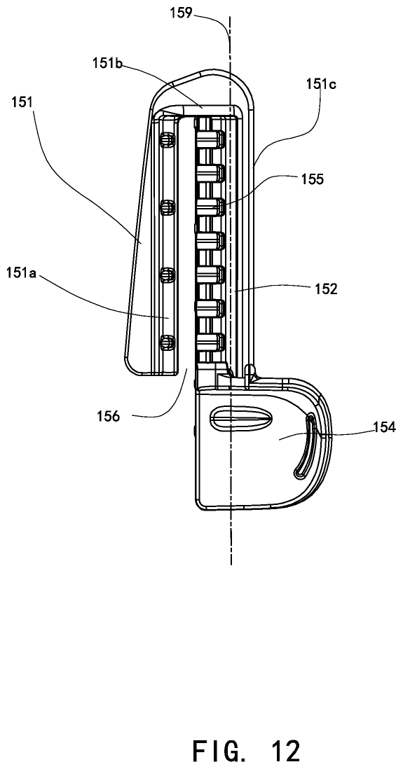

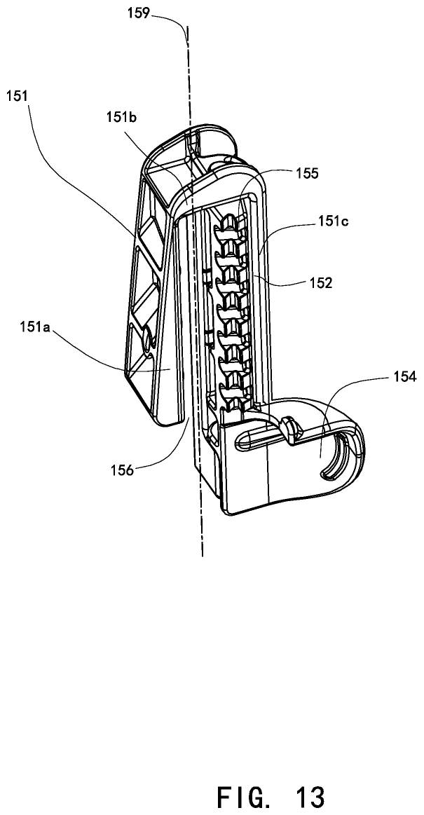

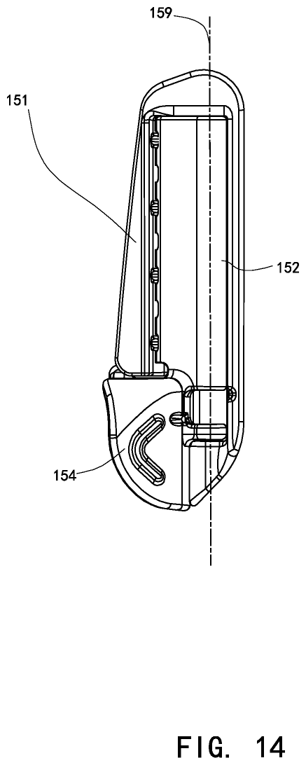

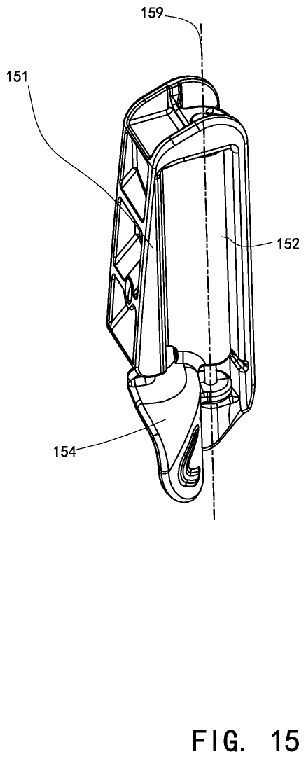

Each of the clamp members 150 includes a case 151, a clamp portion 152, and an elastic member 153. The case 151 is embedded into a side face of the seat body 100, and at least partially accommodates other components of the clamp members 150. Referring to FIGS. 12 to 15, the case 151 has a structure surrounded on three sides, that is, it has a front wall 151a, a top wall 151b and a rear wall 151c, connected with each other, and has an opening 156 to allow the safety belt 200 to enter the case 151. The clamp portion 152 can be pivoted around a substantially vertical pivot axis 159 in respect to the case 151 between an open position and a closed position. When the clamp portion 152 is in the open position, a space is formed between the clamp portion 152 and the case 151 in which the safety belt 200 can be inserted. When the clamp portion 152 is in the closed position, the clamp portion 152 can abut against the case 151 to clamp the safety belt 200 inserted between the clamp portion 152 and the case 151. The elastic member 153 is disposed between the case 151 and the clamp portion 152 to bias the clamp portion 152 to the closed position.

The structure of the clamp member 150 allows for attachment of the safety belt 200 with simple operation, and it also enables the safety belt 200 to extend into the passage 130 of the child safety seat 1 through the clamp member 150.

In an embodiment, the clamp portion 152 is provided with engaging teeth 155 at an edge abutting against the case 151, and when the clamp portion 152 is in the closed position, the engaging teeth 155 abut against the case 151 to reinforce the clamping on the safety belt 200.

The clamp portion 152 is provided with an actuating portion 154 at one end for applying an external force to overcome an acting force of the elastic member 153, so as to pivot the clamp portion 152 to the open position. In an embodiment, the actuating portion 154 is disposed at the bottom end of the clamp portion 152, and the pivot axis 159 is located on the front side of the clamp portion 152. In other embodiments, the actuating portion 154 may also be disposed at the top end of the clamp portion 152, and the pivot axis 159 may be located on the rear side of the clamp portion 152 as well. When the clamp portion 152 is in the closed position, the actuating portion 154 closes the opening at the bottom end of the case 151 to prevent the safety belt 200 from sliding out of the case 151 through the opening of the case 151, and the actuating portion 154 at least partially protrudes transversely to the outside of the case 151, so as to facilitate the user to pull the clamp portion 152. When the child safety seat 1 is impacted, the limit members 140 bears the safety belt 200 and restricts the movement of the safety belt 200. With cooperation of the arrangement of the clamp members 150, the risk of the safety belt 200 slipping out of the opening is effectively reduced.

In an embodiment, the elastic member 153 is a torsion spring, which is disposed at the pivot axis 159 and has two torsion spring feet (not shown) respectively abutting against the case 151 and the clamp portion 152. In other embodiments, the elastic member 153 may also be a compression spring or some other elastic material.

In an embodiment, the child safety seat 1 may further comprises a protrusion 160, so as to further engage the safety belt 200. The seat body 100 may be provided with protrusions 160 on both sides, respectively. The protrusions 160 extend forward from an inner side wall of the back frame 120 and are formed in the passage 130, so as to limit an upward movement of a portion of the safety belt 200 (e.g., a shoulder belt 210 or a waist belt 220, which will be described in detail later) from moving upward relative to the seat body 100.

The protrusions 160 are designed to limit the movement of both the shoulder belt 210 and waist belt 220 of the safety belt 200, ensuring that the child safety seat 1 is more securely engaged.

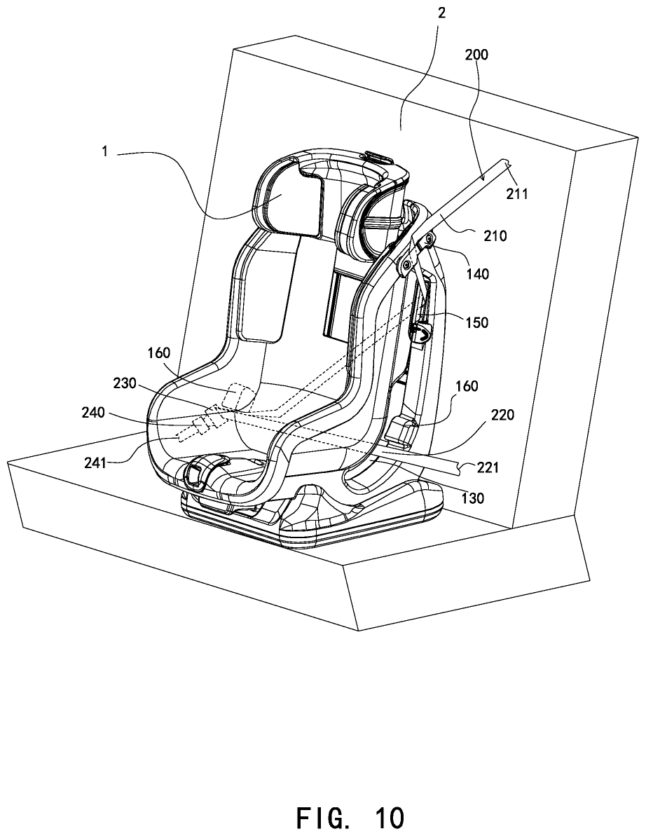

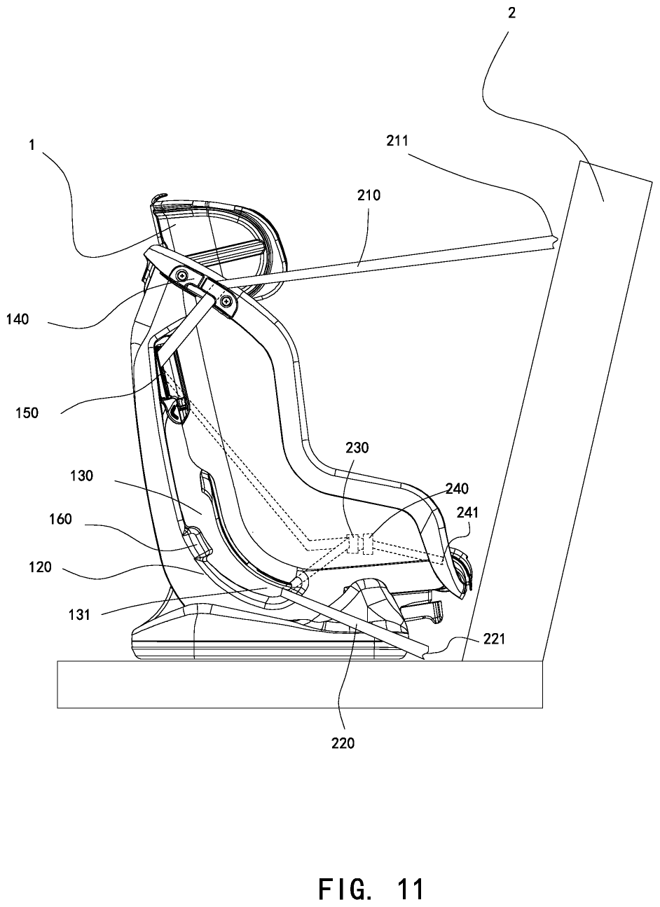

Referring to FIGS. 10 and 11, the operation of engaging the safety belt 200 to the child safety seat 1 according to the application will be described.

The application is suitable to be used in a common automobile safety belt 200. The safety belt 200 comprises a shoulder belt 210, a waist belt 220, a fastening member 230, and an opposed fastening member 240. The shoulder belt 210 and the waist belt 220 respectively extend from upper and lower ends of the vehicle seat 2, and are converged and connected to fastening member 230, moreover, at least one of the shoulder belt 210 and the waist belt 220 can be drawn out of the vehicle seat 2, such that the length of shoulder belt 210 and/or the waist belt 220 is variable. The fastening member 230 is connected to a lower end of the vehicle seat 2 through the opposed fastening member 240 on the vehicle seat 2, such that the safety belt 200 has a triangular configuration. That is, the child safety seat 1 of the application can be applied to a common safety belt 200 with triangular configuration. The shoulder belt 210, the waist belt 220, and the opposed fastening member 240 respectively have a shoulder belt engaging end 211, a waist belt engaging end 221, and a opposed fastening member engaging end 241 which are engaged to the vehicle seat 2. The shoulder belt engaging end 211 is located at the upper end of the vehicle seat 2, and the waist belt engaging end 221 and the opposed fastening member engaging end 241 are located at the lower end of the vehicle seat 2 and are transversely spaced apart and located on the left and right sides of the occupant respectively. The way in which the shoulder belt engaging end 211, the waist belt engaging end 221, and the opposed fastening member engaging end 241 are connected to the vehicle seat 2 is known in the art and can be varied according to the specific use situation, so the detailed description of these parts is omitted in the application.

When the child safety seat 1 is mounted to the vehicle seat 2 in the forward position shown in FIG. 10, the safety belt 200 is engaged according to the following operations: pulling out the safety belt 200 from the vehicle seat 2; bring the shoulder belt 210 through the slot 143 of the limit member 140 and into the gap between the limit member 140 and the seat body 100; rotating the clamp portion 152 of the clamp member 150 to the open position, inserting the shoulder belt 210 between the clamp portion 152 and the case 151, and releasing the clamp portion 152 in order to clamp the shoulder belt 210 in the clamp member 150; bring the part of the shoulder belt 210 that passed through the clamp portion 152, as well as the waist belt 220 and the fastening member 230, through the passage 130 to reach the other side of the child safety seat 1; engaging the fastening member 230 to the opposed fastening member 240; tightening the safety belt 200, such that the waist belt 220 is located below the protrusions 160 on both sides to prevent the waist belt 220 from sliding up; and the shoulder belt 210 may be located below the corresponding protrusion 160 on one side.

When the child safety seat 1 is mounted to the vehicle seat 2 in the rearward position shown in FIG. 11, the safety belt 200 is engaged according to a similar manner as that shown in FIG. 10, only except that the limit member 140 and the clamp member 150 on the other side are used, and the waist belt 220 is not located below the protrusion 160, but located in the longitudinal portion 131 of the passage 130, so as to better tighten the seat 1 toward the backrest of the vehicle seat 2.

It should be understood that it is not necessary to strictly follow the above operation sequence to engage the safety belt 200 to the limit member 140 and the clamp member 150. When the child safety seat 1 is mounted to the vehicle seat 2 in the forward position or the rearward position, the safety belt 200 may be initially engaged to the limit member 140, and then engaged to the clamp member 150, or alternatively, the safety belt 200 may be initially engaged to the clamp member 150, and then engaged to the limit member 140.

It can be seen, when the child safety seat 1 is in the forward position or the rearward position, the engagement between the safety belt 200 and the child safety seat 1 is the same. Moreover, because both sides of the child safety seat 1 are provided with the limit members 140 and the clamp members 150, the child safety seat 1 is capable of being adapted to a left-handed setting (the shoulder belt engaging end 211 and the waist belt engaging end 221 are on the left hand side of the occupant) or a right-handed setting (the shoulder belt engaging end 211 and the waist belt engaging end 221 are on the right hand side of the occupant) of the safety belt 200.

According to the safety belt engaging method of the application, when the child safety seat 1 is in the forward position or the rearward position, the safety belt 200 can be engaged to the child safety seat 1 by the same engaging manner, thereby simplifying the operation and avoiding the risk of improper engagement.

Since the application can be embodied in various forms without departing from the spirit and essence of the application, it should be understood, the above embodiments are not limited to any of the foregoing details, but should be interpreted as broadly as possible within the scope defined by the claims, and therefore all changes that fall within the scope of the claims or their equivalents should be covered by the claims.

### LIST OF REFERENCE SIGNS

1: Child Safety Seat
   101: Base
   100: Seat Body
      110: Seating Portion
      120: Back Frame
      130: Passage
         131: Longitudinal Portion
      140: Limit member
         141: Limiting Piece
         143: Slot
         144: Limiting Space
      150: Clamp Member
         151: Case
         151a: Front Wall
         151b: Top Wall
         151c: rear Wall
         152: Clamp Portion
         153: Elastic Member
         154: Actuating Portion
         155: Engaging Tooth
         156: Opening
         159: Pivot Axis
      160: Protrusion
2: Vehicle seat
   200: Safety Belt
      210: Shoulder Belt
         211: Shoulder Belt Engaging End
      220: Waist Belt
         221: Waist Belt Engaging End
      230: Fastening Member
      240: Opposed Fastening Member
         241: Opposed Fastening Member Engaging End

1. A child safety seat, comprising:
a seat body, engageable to a vehicle seat by a safety belt on the vehicle seat;
characterized in that the child safety seat is mountable to the vehicle seat in a forward position or a rearward position, wherein the child safety seat is provided with a first engagement point and a second engagement point, and wherein in both the forward position and the rearward position, the safety belt engages the child safety seat to the vehicle seat through both the first engagement point and the second engagement point.

2. The child safety seat according to claim 1, wherein:
the child safety seat further comprises:
a limit member, forming the first engagement point, mounted on a side of an upper part of the seat body, and allowing the safety belt to be passed therein; and
a clamp member, forming the second engagement point, mounted at a position on a side of the seat body and below the limit member, and allowing the safety belt to be clamped and passed therein.

3. The child safety seat according to claim 2, wherein:
the child safety seat further comprises:
a passage, transversely passing through a back of the seat body and located below the clamp member, and
wherein the safety belt is able to pass from one side of the child safety seat through the limit member and the clamp member located on that side, as well as the passage, and reach the other side of the child safety seat.

4. The child safety seat according to claim 3, wherein:
two limit members are symmetrically arranged on both sides of the seat body and close to a top of the seat body; and
two clamp members are symmetrically arranged on both sides of the seat body and located at an upper middle position of the seat body.

5. The child safety seat according to claim 2, wherein:
the limit member includes:
a limiting piece, extending along a top frame of the seat body, with two ends respectively mounted to a side of the seat body and a portion between the two ends spaced apart from a side face of the seat body by a limiting space, the limiting space has a length greater than a width of the safety belt and a thickness greater than a thickness of the safety belt; and
a slot, separating the limiting piece into two sections, wherein the slot has a slot width no less than the thickness of the safety belt, to allow the safety belt to enter the limiting space from an outside of the child safety seat through the slot.

6. The child safety seat according to claim 2, wherein:
the clamp member includes:
a case, embedded in a side face of the seat body;
a clamp portion, pivotable about a substantially vertical pivot axis in respect to the case between an open position and a closed position, and when the clamp portion is in the open position, a space is formed between the clamp portion and the case for inserting the safety belt, and when the clamp portion is in the closed position, the clamp portion is able to abut against the case to clamp the safety belt inserted between the clamp portion and the case; and
an elastic member, disposed between the case and the clamp portion to bias the clamp portion towards the closed position.

7. The child safety seat according to claim 6, wherein:
the clamp portion is provided with engaging teeth at an edge abutting against the case, and when the clamp portion is in the closed position, the engaging teeth abut against the case to reinforce a clamping of the safety belt; and
the clamp portion is provided with an actuating portion at one end for applying an external force to overcome a biasing of the elastic member, so as to pivot the clamp portion to the open position.

8. The child safety seat according to claim 7, wherein:
the elastic member is a torsion spring.

9. The child safety seat according to claim 3, wherein:
the seat body is provided with protrusions respectively on both sides, and the protrusions are formed in the passage and extend forward from an inner side wall of a back frame of the seat body, so as to limit an upward movement of a portion of the safety belt-relative to the seat body.

10. The child safety seat according to claim 9, wherein:
the safety belt comprises: a shoulder belt, a waist belt, and a fastening member, wherein the shoulder belt and the waist belt respectively extend from upper and lower ends of the vehicle seat and are converged and connected to the fastening member, wherein a length of at least one of the shoulder belt and the waist belt is variable, and the fastening member is connected to a lower end of the vehicle seat through an opposed fastening member on the vehicle seat, such that the safety belt has a triangular configuration.

11. A safety belt engagement method for the child safety seat according to claim 1, wherein the method comprises:
when the child safety seat is mounted to the vehicle seat in the forward position, engaging the safety belt to the first engagement point and the second engagement point on one side of the seat body; and
when the child safety seat is mounted to the vehicle seat in the rearward position, engaging the safety belt to the first engagement point and the second engagement point on the other side of the seat body.
